(19) United States
(12) Patent Application Publication
(10) Pub. No.: US 2023/0354978 A1
(43) Pub. Date: Nov. 9, 2023

(54) WIRELESS HAIR STRAIGHTENER WITH DUAL HEATER

(71) Applicant: MANGOSLAB CO., LTD., Seongnam (KR)

(72) Inventors: Sang Bong Lee, Ansan-si (KR); Jiwon Lee, Yongin-si (KR); Kwangyong Lee, Gunpo-si (KR); Sumin Lee, Seongnam-si (KR)

(21) Appl. No.: 18/221,571

(22) Filed: Jul. 13, 2023

Related U.S. Application Data
(63) Continuation of application No. PCT/KR2021/011585, filed on Aug. 30, 2021.

(30) Foreign Application Priority Data
Jan. 15, 2021 (KR) 10-2021-0005981

(51) Int. Cl. A45D 2/00; A45D 1/28; A45D 1/06

(52) U.S. Cl. CPC A45D 2/001; A45D 1/28; A45D 1/06; A45D 2001/045

(57) ABSTRACT

A wireless hair straightener according to an embodiment of the present invention includes a battery charged by an external power supply, a first switch, a first heating resistor, and a second heating resistor which are sequentially connected in series between one end of the external power supply and a ground, a second switch having one end connected to a connection point between the first switch and the first heating resistor and the other end connected to the ground, a third switch having one end connected to a connection point between the first heating resistor and the second heating resistor and the other end connected to one end of the battery, and a control unit that controls on and off operations of the first switch, the second switch, and the third switch, in which the other end of the battery is connected to the ground, and the other end of the external power supply is connected to the ground.

### CROSS-REFERENCE TO RELATED APPLICATION

The present application is a continuation of International Patent Application No. PCT/KR2021/011585, filed on Aug. 30, 2021, which is based upon and claims the benefit of priority to Korean Patent Application No. 10-2021-0005981, filed on Jan. 15, 2021. The disclosures of the above-listed applications are hereby incorporated by reference herein in their entirety.

### TECHNICAL FIELD

The present disclosure relates to a wireless hair straightener, and more particularly, to a wireless hair straightener equipped with a dual heater.

### BACKGROUND

A hair straightener is used for hair styling. In recent years, demand for the hair straightener is increasing not only in hair salons but also in each household. This hair straightener may be used to create various types of hair styling, such as straightening hair or giving curling such as a wave by putting hair between a pair of hot heating plates and applying heat.

The related wired hair straightener supplies AC input power to the heater, and thus can be rapidly heated to a high temperature although the heater resistance increases as the temperature rises. However, since the wireless hair straightener uses a battery with a limited output, it is difficult to continuously supply the same energy when the resistance of the heater increases as the temperature rises. Accordingly, there is a need for a wireless hair straightener capable of providing heating performance similar to that of a wired hair straightener.

### SUMMARY

### Technical Problem

Embodiments disclosed herein provide a power control apparatus with a dual heater that can be applied when a heating resistor having a large TCR is used as a heater and when a heating resistor having a small temperature coefficient of resistance (TCR) is used as a heater, respectively, and a method thereof.

### Technical Solution

According to an embodiment of the present disclosure, a wireless hair straightener includes a battery charged by an external power supply, a first switch, a first heating resistor, and a second heating resistor which are sequentially connected in series between one end of the external power supply and a ground, a second switch having one end connected to a connection point between the first switch and the first heating resistor and the other end connected to the ground, a third switch having one end connected to a connection point between the first heating resistor and the second heating resistor and the other end connected to one end of the battery, and a control unit that controls on and off operations of the first switch, the second switch, and the third switch, in which the other end of the battery is connected to the ground, and the other end of the external power supply is connected to the ground.

According to an embodiment, in the wireless hair straightener, the first switch is a P-channel MOSFET, the second switch is an N-channel MOSFET, and the third switch is a P-channel MOSFET.

According to an embodiment, the first heating resistor and the second heating resistor of the wireless hair straightener are ceramic heaters using molybdenum or tungsten as a heating element, and the first heating resistor and the second heating resistor have the same resistance value.

According to an embodiment, in the wireless hair straightener, in a first operation mode in which a temperature of the first heating resistor and the second heating resistor is heated to a target temperature, the control unit controls the first switch to be off, controls on and off switching operation of the second switch in accordance with a duty ratio of a PWM signal, and control the third switch to be on, in which the duty ratio of the PWM signal is determined by a following equation so as not to exceed a maximum current output of the battery:

$$PWM duty ratio ( high ) = TCR \times \frac{\frac{{I}_{max}}{2} - \frac{V}{TCR}}{V}$$

where, TCR is a variable resistance value of the first heating resistor, Imax is a maximum current output of the battery, and V is a voltage value that varies according to charging and discharging states of the battery.

According to an embodiment, in the wireless hair straightener, the control unit is configured to, in a second operation mode in which the temperature of at least one of the first heating resistor or the second heating resistor is maintained at a target temperature, when the external power supply is not connected, control the first switch and the second switch to be off, and control switching operation of the third switch in accordance with the PWM duty ratio for maintaining the second heating resistor at the target temperature, and when the external power supply is connected, control switching operation of the first switch in accordance with the PWM duty ratio for maintaining the first heating resistor and the second heating resistor at the target temperature, and control the second switch and the third switch to be off.

According to another embodiment of the present disclosure, a wireless hair straightener includes a first switch, a first heating resistor, a second heating resistor, a second switch, and a battery sequentially connected in series between one end of an external power supply and a ground, and a control unit that controls on and off the first switch and the second switch, in which the battery is charged by the external power supply, a connection point between the first heating resistor and the second heating resistor is connected to a ground, and the other end of the external power supply is connected to the ground.

According to an embodiment, in the wireless hair straightener, the first switch is a P-channel MOSFET, and the second switch is a P-channel MOSFET.

According to an embodiment, in the wireless hair straightener, the first heating resistor and the second heating resistor are ceramic heaters using palladium as a heating element, and the first heating resistor has a higher resistance value than the second heating resistor.

According to an embodiment, in the wireless hair straightener, in a first operation mode in which a temperature of the first heating resistor and the second heating resistor is heated to a target temperature, when the external power supply is not connected, the control unit controls the first switch to be off, controls the second switch to be on, and controls the first switch to be on and controls the second switch to be on, when the external power supply is connected.

According to an embodiment, in the wireless hair straightener, the control unit is configured to, in a second operation mode in which a temperature of the first heating resistor and the second heating resistor is maintained at a target temperature, when the external power supply is not connected, control the first switch to be off, and control switching operation of the second switch according to a PWM duty ratio for maintaining the target temperature, and when the external power supply is connected, control switching operation of the first switch according to a PWM duty ratio for maintaining the target temperature, and control the second switch to be off.

### Advantageous Effects

According to various embodiments of the present disclosure, the wireless hair straightener can efficiently use power by arrangement of a plurality of heating resistors on each heating plate.

According to various embodiments of the present disclosure, the wireless hair straightener uses a high-output battery to rapidly increase the temperature of the heating plate, thereby reducing the time required for the user's hair styling.

According to various embodiments of the present disclosure, when a power adapter is connected, the wireless hair straightener uses external power supply to maintain the temperature of the heating plate, and also controls the battery such that charging or discharging does not occur, and accordingly, it is possible to increase the use time of the battery and efficiently manage the lifespan of the battery.

The effects of the present disclosure are not limited to the effects described above, and other effects that are not mentioned above can be clearly understood to those skilled in the art based on the description provided below.

### BRIEF DESCRIPTION OF THE DRAWINGS

Embodiments of the present disclosure will be described with reference to the accompanying drawings described below, where similar reference numerals indicate similar elements, although the embodiments are not limited thereto.

FIG. 1 is a perspective view of a wireless hair straightener according to an embodiment of the present disclosure.

FIG. 2 illustrates a wireless hair straightener control circuit using a heating resistor having a characteristic of high temperature coefficient resistance (TCR) according to an embodiment of the present disclosure.

FIG. 3 is a diagram illustrating an operation in a first operation mode of a wireless hair straightener using a heating resistor having a characteristic of high TCR according to an embodiment of the present disclosure.

FIG. 4 is a diagram illustrating an operation in a second operation mode in a state in which an external power supply is connected to a wireless hair straightener using a heating resistor having a characteristic of high TCR according to an embodiment of the present disclosure.

FIG. 5 is a diagram illustrating an operation in a second operation mode in a state in which an external power supply is not connected to a wireless hair straightener using a heating resistor having a characteristic of high TCR according to an embodiment of the present disclosure.

FIG. 6 is a table illustrating states of switches for each of operation modes of a wireless hair straightener using a heating resistor having a characteristic of high TCR according to an embodiment of the present disclosure.

FIG. 7 illustrates a wireless hair straightener control circuit using a heating resistor having a characteristic of low TCR according to an embodiment of the present disclosure.

FIG. 8 is a diagram illustrating an operation in a first operation mode of a wireless hair straightener using a heating resistor having a characteristic of low TCR according to an embodiment of the present disclosure.

FIG. 9 is a diagram illustrating an operation in a second operation mode of a wireless hair straightener using a heating resistor having a characteristic of low TCR according to an embodiment of the present disclosure.

FIG. 10 is a table illustrating states of switches for each of operation modes of a wireless hair straightener using a heating resistor having a characteristic of low TCR according to an embodiment of the present disclosure.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of the embodiments, duplicate descriptions of the same or corresponding components may be omitted. However, even if descriptions of elements are omitted, it is not intended that such elements are not included in any embodiment.

Advantages and features of the disclosed embodiments and methods of accomplishing the same will be apparent by referring to examples described below in connection with the accompanying drawings. However, the present disclosure is not limited to the embodiments disclosed below, and may be implemented in various forms different from each other, and the embodiments are merely provided to make the present disclosure complete, and to fully disclose the scope of the disclosure to those skilled in the art to which the present disclosure pertains.

The terms used herein will be briefly described prior to describing the disclosed embodiment(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly displays the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an embodiment of the present disclosure, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

The statement “A and/or B” herein means “A”, or “B”, or “A and B.”

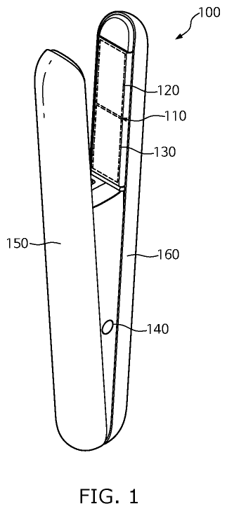

FIG. 1 is a perspective view of a wireless hair straightener 100 according to an embodiment of the present disclosure. Referring to FIG. 1, the wireless hair straightener 100 includes a heating plate 110, a power button 140, a first arm 150, and a second arm 160. A first heating resistor 120 and a second heating resistor 130 may be disposed within the heating plate 110.

The heating plate 110 may be supplied with power from an external power supply (AC power source, not illustrated) or from a battery (DC power source, not illustrated) disposed in the wireless hair straightener 100. The first heating resistor 120 and the second heating resistor 130 disposed within the heating plate supplied with power from an external power supply or a battery may operate as the heating elements.

FIG. 1 illustrates that the heating plate 110 including two heating resistors 120 and 130 is disposed on the second arm 160 of the wireless hair straightener 100, but aspects are not limited thereto, and a heating plate including two heating resistors may be disposed on the first arm 150 of the wireless hair straightener 100 in the same manner. In addition, the first heating resistor 120 and the second heating resistor 130 are named only for the purpose of distinguishing one from the other, and the role of the heating resistors to be described below is not limited by the names. The user may grab the first arm 150 and the second arm 160 of the wireless hair straightener 100 and place his or her hair between the heating plates of the arms and perform hair styling.

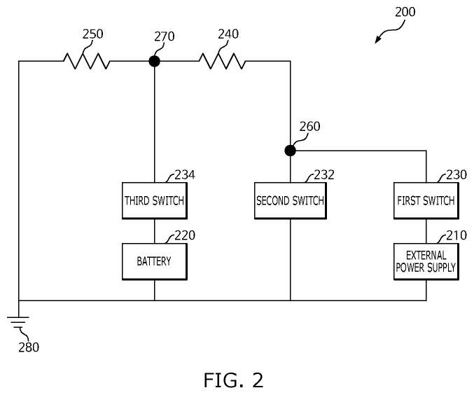

FIG. 2 illustrates a wireless hair straightener control circuit using a heating resistor having a characteristic of high temperature coefficient resistance (TCR) according to an embodiment of the present disclosure. If a ceramic heater is used as the heating resistor in the hair straightener, the temperature coefficient resistance (TCR) characteristics are different from each other depending on the material of the heating resistor metal. FIG. 2 illustrates a wireless hair straightener control circuit when heating resistors 240 and 250 having a characteristic of of high TCR are used.

As illustrated, the control circuit 200 includes a battery 220, a first switch 230, a second switch 232, a third switch 234, a first heating resistor 240, a second heating resistor 250, and a ground 280, and may be connected to an external power supply 210. In addition, the control circuit 200 may further include a control unit (not illustrated) for controlling on and off the first switch 230, the second switch 232, and the third switch 234. In an embodiment, the first heating resistor 240 and the second heating resistor 250 may have the same resistance value. For example, the first heating resistor 240 and the second heating resistor 250 may have a resistance value of 2.5 Ω. In an embodiment, the first heating resistor 240 and the second heating resistor 250 may be ceramic heaters using molybdenum, tungsten, or the like as a heating element. For example, the heating resistor may be manufactured by coating a heating metal pattern such as molybdenum or tungsten on a ceramic sheet and laminating the ceramics. In addition, the first switch 230 and the third switch 234 may be P-channel MOSFETs, and the second switch 232 may be a N-channel MOSFET.

The first switch 230, the first heating resistor 240, and the second heating resistor 250 may be sequentially connected in series between one end of the external power supply 210 and the ground 280. In addition, one end of the second switch 232 may be connected to a connection point 260 between the first switch 230 and the first heating resistor 240, and the other end may be connected to the ground 280. One end of the third switch 234 may be connected to a connection point 270 between the first heating resistor 240 and the second heating resistor 250, and the other end may be connected to one end of the battery 220. The other end of the external power supply 210 and the other end of the battery 220 may be connected to the ground 280. If the wireless hair straightener is connected to the external power supply 210, the battery 220 may be connected (not illustrated) to the external power supply 210 so as to be charged. The control unit (not illustrated) may control on and off the first switch 230, the second switch 232, and the third switch 234 according to whether the external power supply 210 is connected or not and the operating state of the wireless hair straightener, as will be described below.

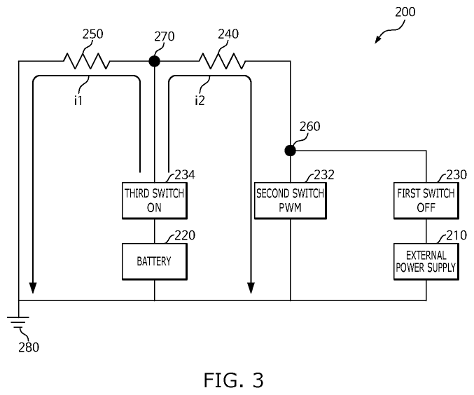

FIG. 3 is a diagram illustrating an operation in a first operation mode of a wireless hair straightener using a heating resistor having a characteristic of high TCR according to an embodiment of the present disclosure. In this example, the first operation mode may refer to a temperature rising section in which the temperature of the first heating resistor 240 and the second heating resistor 250 is heated to a target temperature (e.g., 200° C.). For example, when a user turns on a power source of the wireless hair straightener and heats the heating plates to a target temperature, the control unit may control the wireless hair straightener to operate in the first operation mode.

In the first operation mode, it is important to increase the temperature of the heating plates to the target temperature within a short period of time as possible. Since the first heating resistor 240 and the second heating resistor 250 have high TCR, the resistance values of the first heating resistor 240 and the second heating resistor 250 increase as the temperature of the heating plate increases. Although the resistance value may increase, by controlling on and off the second switch 232 to continuously supply the maximum output current of the battery 220 to the heating plate, the maximum output current of the battery 220 is maintained. If both the first heating resistor 240 and the second heating resistor 250 are controlled to be on from the room temperature, it will result in the maximum current output (e.g., 7.5 A) of the battery 220 being exceeded. The control unit may control the first switch 230 to be off so as not to exceed the maximum output of the battery 220, control the on and off switching operation of the second switch 232 in accordance with the duty ratio of a Pulse Width Modulation (PWM) signal (so that the average current value does not exceed the maximum current output of the battery), and control the third switch 234 to be on.

In an embodiment, in order not to exceed the maximum current output of the battery 220, the duty ratio of the PWM signal applied to the second switch 232 may be determined by the following equation so as not to exceed the maximum current output of the battery 220.

$$PWM duty ratio ( high ) - TCR \times \begin{matrix}\frac{{I}_{max}}{2} - \frac{V}{TCR} \\ V\end{matrix}$$

Here, TCR may denote a variable resistance value of the first heating resistor 240 and the second heating resistor 250, Imax may denote the maximum current output of the battery 220, and V may denote a voltage value that varies according to charging and discharging states of the battery 220. For reference, since TCRs of the first heating resistor 240 and the second heating resistor 250 are varied likewise and the current of the battery 220 is divided and flows into the first arm (not illustrated) and the second arm (not illustrated), in order to calculate the duty ratio of the PWM signal, half of the maximum current output of the battery 220 (Imax/2) may be used in the equation.

According to the control of the control unit described above, a first current i1 flows through the second heating resistor 250 and a second current i2 flows through the first heating resistor 240 according to the duty ratio of the PWM signal. The control unit may control the switches as described above in the first operation mode both when the external power supply 210 is connected to the wireless hair straightener and when it is not connected to the wireless hair straightener. In addition, when the external power supply 210 is connected to the wireless hair straightener, the control unit may deactivate charging of the battery 220 when the battery 220 is in a full state, and activate charging of the battery 220 when not in the full state.

When the wireless hair straightener is operated in a third operation mode (heat loss section), the control unit may control the switches in the same manner as in the first operation mode. In this example, the third operation mode may refer to a section in which the temperature of the first heating resistor 240 and the second heating resistor 250 is heated again to a target temperature (e.g., 200° C.) when the heating plates that maintained the target temperature now lose heat as they are used by the user (e.g., for wet hair). In this case, it is necessary to increase the output for quick temperature compensation, but since it is difficult to increase the instantaneous output for temperature compensation with the external power supply 210, the control unit may switch the power control in the same manner as in the first operation mode (temperature rising section) and then switch to a second operation mode to be described below when the temperature is stabilized.

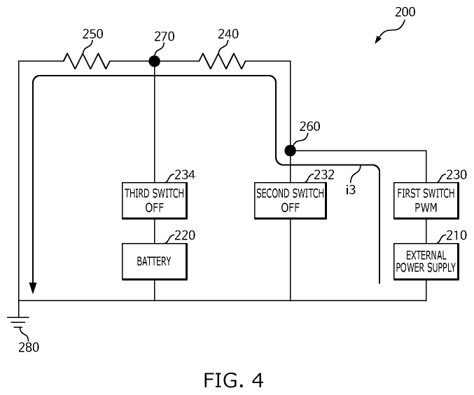

FIG. 4 is a diagram illustrating an operation in the second operation mode in a state in which the external power supply 210 is connected to a wireless hair straightener using a heating resistor having a characteristic of high TCR according to an embodiment of the present disclosure. In this example, the second operation mode may refer to a temperature holding period in which the first heating resistor 240 and the second heating resistor 250 are maintained at a target temperature (e.g., 200° C.). For example, when the temperature of the heating plates of the wireless hair straightener reaches the target temperature through the first operation mode (temperature rising section), the control unit (not illustrated) may control the wireless hair straightener to operate in the second operation mode. Specifically, when the external power supply 210 is connected to the wireless hair straightener, in the second operation mode, the control unit may control the switching operation of the first switch 230 in accordance with the PWM duty ratio for maintaining the first heating resistor 240 and the second heating resistor 250 at target temperatures, and control the second switch 232 and the third switch 234 to be off.

In the second operation mode, it is important to maintain the target temperature of the heating plates. Since maintaining the target temperature does not require large current, the target temperature can be maintained with the external power supply 210 alone. For example, if the target temperature is 180° C., the resistance value in the case of tungsten may increase by about 1.6 times compared to room temperature (25° C.), increasing from 2.5Ω to 4Ω, although the resistance values of the heating resistors 240 and 250 in the temperature holding section may vary depending on the material. If the output current of the external power supply 210 is used at room temperature, the resistance may be 2.5Ω and the Over Power Protection (OCP) range of the external power supply 210 may be exceeded, but when the power is controlled in a state where the resistance is increased, the two heating resistors 240 and 250 may become heating resistors 240 and 250 of a single resistance connected in series with each other. At this time, since the resistance value of the heating resistors 240 and 250 is about 8Ω, it is possible to maintain temperature without the highest current exceeding the OCP range of the external power supply 210 and with the average current staying within the output range of the external power supply 210, while controlling the first heating resistor 240 and the second heating resistor 250 with the external power supply 210. In addition, since the lifespan of the battery 220 is shortened when the output current of the battery 220 is continuously supplied to the heating plate, the third switch 234 may be controlled to be off. According to the control of the control unit described above, a third current i3 may flow from the external power supply 210 through the first heating resistor 240 and the second heating resistor 250. In addition, in the second operation mode, the control unit may deactivate the charging of the battery 220 even when the external power supply 210 is connected to the wireless hair straightener.

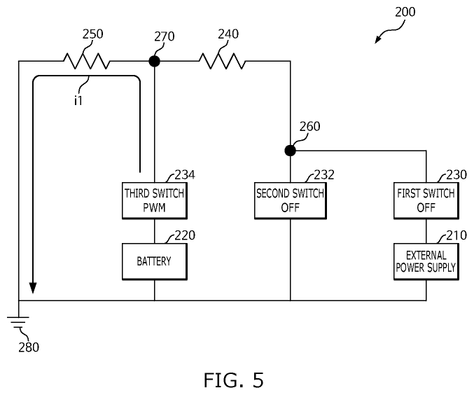

FIG. 5 is a diagram illustrating an operation in the second operation mode in a state in which an external power supply 210 is not connected to a wireless hair straightener using a heating resistor having a characteristic of high TCR according to an embodiment of the present disclosure. As illustrated, when the external power supply 210 is not connected to the wireless hair straightener, in the second operation mode, the control unit may control the first switch 230 and the second switch 232 to be off, and control the switching operation of the third switch 234 in accordance with the PWM duty ratio for maintaining the second heating resistor 250 at a target temperature. According to the control by the control unit described above, the first current i1 may flow from the battery 220 through the second heating resistor 250.

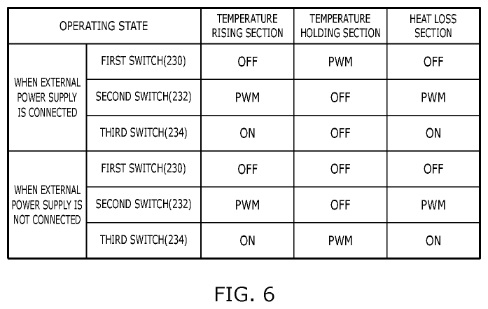

FIG. 6 is a table illustrating states of switches for each of operation modes of a wireless hair straightener using a heating resistor having a characteristic of high TCR according to an embodiment of the present disclosure. In this example, each switch may be controlled differently according to whether an external power supply is connected or not and an operating state. As described above, in the first operation mode (temperature rising section) and the third operation mode (heat loss section), the control unit may equally control the first to third switches 230, 232, and 234 regardless of whether external power supply is connected or not.

In the second operation mode (temperature holding section), the control unit may control each switch differently depending on whether the external power supply is connected or not. When the external power supply is connected, the control unit may control the switching operation of the first switch 230 in accordance with the PWM duty ratio in order to maintain a target temperature, and control the second switch 232 and the third switch 234 to be off. On the other hand, when the external power supply is not connected, the control unit may control the first switch 230 and the second switch 232 to be off, and control the switching operation of the third switch 234 in accordance with the PWM duty ratio in order to maintain a target temperature.

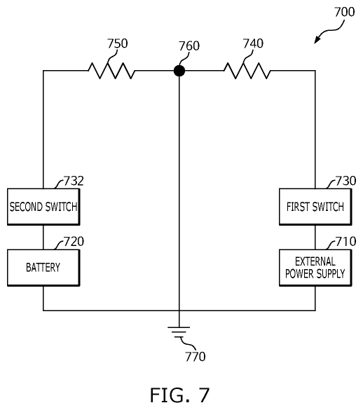

FIG. 7 illustrates a wireless hair straightener control circuit 700 using a heating resistor having a characteristic of low TCR according to an embodiment of the present disclosure. The TCR characteristics of the heating resistors in ceramics used for the hair straightener may be different from each other. FIG. 7 illustrates a control circuit 700 of a wireless hair straightener when heating resistors 740 and 750 having a low TCR are used. For example, the first heating resistor 740 and the second heating resistor 750 may be ceramic heaters using palladium as a heating element.

In an embodiment, the first heating resistor 740 may have a higher resistance value than that of the second heating resistor 750. For example, the first heating resistor 740 may be 10Ω, and the second heating resistor 750 may be 2Ω. In addition, the first switch 730 and the second switch 732 may be P-channel MOSFETs.

As illustrated, the control circuit 700 may include an external power supply 710, a battery 720, a first switch 730, a second switch 732, a first heating resistor 740, a second heating resistor 750, and a ground 770. In addition, the control circuit 700 may further include a control unit (not illustrated) for controlling on and off the first switch 730 and the second switch 732. The first switch 730, the first heating resistor 740, the second heating resistor 750, the second switch 732, and the battery 720 may be sequentially connected in series between one end of the external power supply 710 and the ground 770. A connection point 760 between the first heating resistor 740 and the second heating resistor 750 may be connected to the ground 770, and the other end of the external power supply 710 may be connected to the ground 770. In addition, if the wireless hair straightener is connected to the external power supply 710, the battery 720 may be connected (not illustrated) to the external power supply 710 so as to be charged. The control unit may control on and off the first switch 730 and the second switch 732 according to whether the external power supply 710 is connected or not and the operating state of the wireless hair straightener, as will be described below.

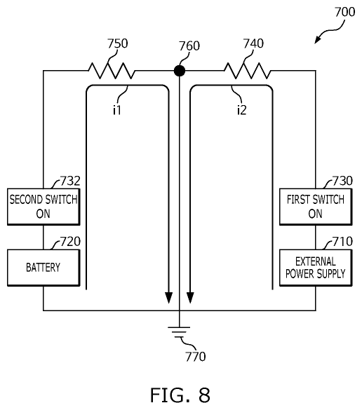

FIG. 8 is a diagram illustrating an operation in a first operation mode of a wireless hair straightener using a heating resistor having a characteristic of low TCR according to an embodiment of the present disclosure. In this example, the first operation mode may refer to a temperature rising section in which the temperature of the first heating resistor 740 and the second heating resistor 750 is heated to a target temperature (e.g., 200° C.). For example, when a user turns on a power source of the wireless hair straightener and heats the heating plates to a target temperature, the control unit may control the wireless hair straightener to operate in the first operation mode (temperature rising section). In this case, the first heating resistor 740 and the second heating resistor 750 may be ceramic heaters using palladium with a low TCR as a heating element.

In the first operation mode, it is important to increase the temperature of the heating plates to the target temperature within a short period of time as possible. Since each of the heating resistors 740 and 750 is a ceramic heater using palladium as a heating element that has a low TCR, the resistance values of the first heating resistor 740 and the second heating resistor 750 may not vary greatly when the temperature of the heating plates rises. As a result, the maximum output of the external power supply 710 and the battery 720 can be supplied to the heating plates. The control unit (not illustrated) may control on and off the first switch 730 and the second switch 732 according to whether the external power supply 710 is connected or not and the operating state of the wireless hair straightener, as will be described below.

As illustrated in FIG. 8, when the external power supply 710 is connected to the wireless hair straightener, the control unit may control the first switch 730 and the second switch 732 to be on. In addition, in the first operation mode, the control unit may deactivate the charging of the battery 720 even when the external power supply 710 is connected to the wireless hair straightener. According to the control by the control unit described above, the first current i1 may flow from the battery 720 through the second heating resistor 750, and the second current i2 may flow from the external power supply 710 through the first heating resistor 740.

On the other hand, when the external power supply 710 is not connected to the wireless hair straightener (not illustrated), in the first operation mode, the control unit may control the first switch 730 to be off, and control the second switch 732 to be on. In this case, the first current i1 may flow from the battery 720 through the second heating resistor 750. Since the first switch 730 is controlled to be off, current does not flow through the first heating resistor 740.

When the wireless hair straightener is operated in the third operation mode (heat loss section), the control unit may control the switches in the same manner as in the first operation mode (temperature rising section). In this example, the third operation mode may refer to a section in which the temperature of the first heating resistor 740 and the second heating resistor 750 is heated to a target temperature (e.g., 200° C.) when the heating plates that maintained the target temperature now lose heat as they are used by the user (e.g., for wet hair). In addition, the control unit may switch the power control in the same manner as in the first operation mode and then switch to the second operation mode to be described below when the temperature is stabilized. In this case, in the third operation mode, the control unit may deactivate the charging of the battery 720 even when the external power supply 710 is connected to the wireless hair straightener.

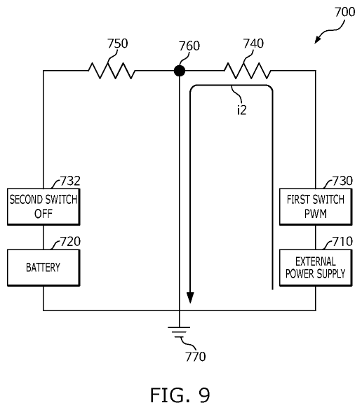

FIG. 9 is a diagram illustrating an operation in a second operation mode of a wireless hair straightener using a heating resistor having a characteristic of low TCR according to an embodiment of the present disclosure. In this example, the second operation mode may refer to a temperature holding period in which the first heating resistor 740 and the second heating resistor 750 are maintained at a target temperature (e.g., 200° C.). For example, when the temperature of the heating plates of the wireless hair straightener reaches the target temperature through the first operation mode (temperature rising section), the control unit (not illustrated) may control the wireless hair straightener to operate in the second operation mode (temperature holding section). Specifically, when the external power supply 710 is connected to the wireless hair straightener, in the second operation mode, the control unit may control switching of the first switch in accordance with the PWM duty ratio for maintaining a target temperature, and control the second switch to be off. In this case, the second current i2 may flow from the external power supply 710 through the first heating resistor 740 in accordance with the PWM duty ratio. In addition, in the second operation mode, the control unit may deactivate the charging of the battery 720 even when the external power supply 710 is connected to the wireless hair straightener.

When the external power supply 710 is not connected to the wireless hair straightener (not illustrated), in the second operation mode, the control unit may control the first switch 730 to be off, and control the switching operation of the second switch 732 in accordance with the PWM duty ratio for maintaining a target temperature. In this case, the first current (not illustrated) may flow from the battery 720 through the first heating resistor 750 in accordance with the PWM duty ratio.

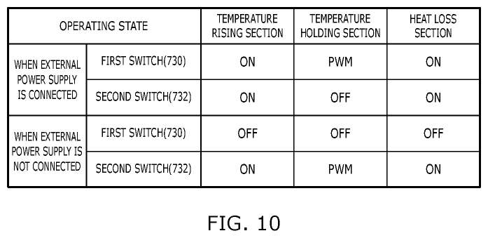

FIG. 10 is a table illustrating states of switches for each of operation modes of a wireless hair straightener using a heating resistor having a characteristic of low TCR according to an embodiment of the present disclosure. In this example, each switch may be controlled differently according to whether an external power supply is connected or not and an operating state. As described above, the control unit may equally control the first switch 730 and the second switch 732 according to whether the external power supply is connected or not, in the first operation mode (temperature rising section) and the third operation mode (heat loss section).

In the second operation mode (temperature holding period), the control unit may control each switch differently depending on whether the external power supply is connected or not. When the external power supply is connected, the control unit may control the switching operation of the first switch 730 in accordance with the PWM duty ratio in order to maintain a target temperature, and control the second switch 732 to be off. On the other hand, when the external power supply is not connected, the control unit may control the first switch 730 to be off, and control the switching operation of the second switch 732 in accordance with the PWM duty ratio in order to maintain a target temperature.

The switch control operation of the wireless hair straightener described above may be implemented as computer readable codes on a computer readable recording medium. The computer-readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the embodiments.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessed by a computer. In addition, any connection is properly referred to as a computer-readable medium.

For example, if the software is sent from a website, server or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the embodiments described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some embodiments herein, various modifications and changes can be made without departing from the scope of the present disclosure, which can be understood by those skilled in the art to which the present disclosure pertains. In addition, such modifications and changes should be considered within the scope of the claims appended herein.

1. A wireless hair straightener comprising:
a battery configured to be charged by an external power supply;
a first switch, a first heating resistor, and a second heating resistor which are sequentially connected in series between a first end of the external power supply and a reference node;
a second switch, wherein a first end of the second switch is connected to a connection point between the first switch and the first heating resistor, and a second end of the second switch is connected to the reference node;
a third switch, wherein a first end of the third switch is connected to a connection point between the first heating resistor and the second heating resistor, and a second end of the third switch is connected to a first end of the battery; and
a controller configured to control on and off operations of the first switch, the second switch, and the third switch, wherein:
a second end of the battery is connected to the reference node, and
a second end of the external power supply is connected to the reference node.

2. The wireless hair straightener according to claim 1, wherein:
the first switch comprises a P-channel metal-oxide-semiconductor field-effect transistor (MOSFET),
the second switch comprises an N-channel MOSFET, and
the third switch comprises a P-channel MOSFET.

3. The wireless hair straightener according to claim 1, wherein:
the first heating resistor and the second heating resistor are ceramic heaters using molybdenum or tungsten as a heating element, and
the first heating resistor and the second heating resistor have a same resistance value.

4. The wireless hair straightener according to claim 1, wherein:
in a first operation mode in which temperatures of the first heating resistor and the second heating resistor reach a target temperature, the controller is configured to:
control the first switch to be off;
control on and off switching operations of the second switch in accordance with a duty ratio of a pulse width modulation (PWM) signal; and
control the third switch to be on,
wherein the duty ratio of the PWM signal is determined by a following equation so as not to exceed a maximum current output of the battery:
$$PWM duty ratio ( high ) = TCR \times \frac{\frac{{I}_{max}}{2} - \frac{V}{TCR}}{V}$$
where, TCR is a variable resistance value of the first heating resistor,
Imax is a maximum current output of the battery, and
V is a voltage value that varies according to charging and discharging states of the battery.

5. The wireless hair straightener according to claim 1, wherein:
in a second operation mode in which a temperature of at least one of the first heating resistor or the second heating resistor is maintained at a target temperature, the controller is configured to:
when the external power supply is not connected,
control the first switch and the second switch to be off, and
control switching operations of the third switch in accordance with a pulse width modulation (PWM) duty ratio for maintaining the second heating resistor at the target temperature, and
when the external power supply is connected,
control switching operations of the first switch in accordance with the PWM duty ratio for maintaining the first heating resistor and the second heating resistor at the target temperature, and
control the second switch and the third switch to be off.

6. The wireless hair straightener according to claim 1, wherein the reference node is a ground node.

7. A wireless hair straightener comprising:
a first switch, a first heating resistor, a second heating resistor, a second switch, and a battery sequentially connected in series between a first end of an external power supply and a reference node; and
a controller configured to control on and off operations of the first switch and the second switch, wherein:
the battery is configured to be charged by the external power supply,
a connection point between the first heating resistor and the second heating resistor is connected to the reference node, and a second end of the external power supply is connected to the reference node.

8. The wireless hair straightener according to claim 7, wherein:
the first switch comprises a P-channel metal-oxide-semiconductor field-effect transistor (MOSFET), and
the second switch comprises a P-channel MOSFET.

9. The wireless hair straightener according to claim 7, wherein:
the first heating resistor and the second heating resistor are ceramic heaters using palladium as a heating element, and
the first heating resistor has a higher resistance value than the second heating resistor.

10. The wireless hair straightener according to claim 7, wherein:
in a first operation mode in which temperatures of the first heating resistor and the second heating resistor reach a target temperature, the controller is configured to:
when the external power supply is not connected, control the first switch to be off and the second switch to be on, and
when the external power supply is connected, control the first switch to be on and the second switch to be on.

11. The wireless hair straightener according to claim 7, wherein:
in a second operation mode in which temperatures of the first heating resistor and the second heating resistor are maintained at a target temperature, the controller is configured to:
when the external power supply is not connected,
control the first switch to be off, and
control switching operations of the second switch according to a pulse width modulation (PWM) duty ratio for maintaining the target temperature, and
when the external power supply is connected,
control switching operations of the first switch according to the PWM duty ratio for maintaining the target temperature, and
control the second switch to be off.

12. The wireless hair straightener according to claim 7, wherein the reference node is a ground node.
